(19) United States
(12) Patent Application Publication
(10) Pub. No.: US 2008/0159803 A1
(43) Pub. Date: Jul. 3, 2008

(54) Writing Instrument and a Method of Manufacturing Such an Instrument

(75) Inventor: Jeanne-Antide Bouveresse, Rueil Malmaison (FR)

Correspondence Address: JONES DAY, 222 EAST 41ST ST, NEW YORK, NY, 10017, US

(73) Assignee: Societe BIC, Clichy Cedex (FR)

(21) Appl. No.: 11/910,400

(22) PCT Filed: Mar. 22, 2006
(86) PCT No.: PCT/FR2006/000503

§ 371 Date: Oct. 1, 2007

(30) Foreign Application Priority Data
Mar. 30, 2005 (FR) 0503097

(51) Int. Cl. B43K 27/00

(52) U.S. Cl. 401/34

(57) ABSTRACT

A writing instrument having a central body and writing tips made of pastel material, the writing instrument being characterized in that it has at least three protuberant tips, each of which is formed of a pastel material of a color different from the colors of two of the other of the protuberant tips, the protuberant tips extending along different axes, each from a base integral with or secured to the central body to a vertex forming a writing tip for writing in the corresponding color, the protuberant tips being formed integrally with the central body, and the pastel materials being of the same chemical nature.

### CROSS-REFERENCE TO RELATED APPLICATIONS

This application is a national stage application of International Application No. PCT/FR2006/000503, filed on Mar. 30, 2005, the entire contents of which are incorporated herein by reference.

### BACKGROUND OF INVENTION

Embodiments of the present invention relate to a writing instrument having writing tips made of a “pastel material”.

Such writing instruments having writing tips made of pastel material, such as pastel crayons, have been known for a long time. They are generally made up of natural or synthetic waxes that are colored by means of color pigments, to which fillers can be added. It should be noted that such writing instruments can be used for writing in the broadest sense of the term, i.e. not only for writing text on a writing medium, but also for doing drawings or coloring.

However, known writing instruments are generally adapted to writing in a single color only or at the most two distinct colors, which makes it necessary to have almost as many crayons as desired colors.

Document CN 2 211 926 describes an example of a crayon having two sticks of pastel material of different colors, placed back-to-back in a tubular element so that the sticks project from the tubular element at opposite ends. Although such a crayon makes it possible to write with either one of the two sticks, it offers the possibility of writing in two distinct colors only. In addition, the presence of the tubular object can hinder writing after prolonged use of the crayon because the pastel material of the sticks that has not yet been used up then finds itself set back from the ends of the tubular element and is no longer accessible without being manipulated.

Document CN 2 531 954 describes a writing instrument that is generally pen-shaped, and in whose body a space is provided for storing a plurality of pastel “leads” of different colors disposed transversely. A recess is also provided at the end of the pen for the purpose of receiving a pastel “lead”. When it is desired to write with another color, the current “lead” is removed from the pen and replaced with a “lead” of desired color that is extracted from the stowage space. Although that pastel pen makes it possible to write selectively in a large number of colors, it is particularly tedious to use, and makes it easy to lose “leads”. In addition, the small size of the “leads” makes it possible to use each color for a limited amount of time only.

### SUMMARY OF THE INVENTION

It is an object of the embodiments of the present invention to limit the drawbacks of prior instruments, and, in particular to make it possible to write selectively in a plurality of colors using a writing instrument that is made of pastel material and that is easy to handle and simple to use.

The embodiments of the present invention thus provides a writing instrument according to claim 1.

The presence of protuberant tips of different colors and extending along different axes thus makes it possible to write without any difficulty in a color chosen from at least three distinct colors.

The fact that the protuberant tips are formed integrally with the central body, with the pastel materials of different colors being of the same chemical nature, creates chemical bonds between the various pastel materials, imparting satisfactory strength to the writing instrument even if has relatively complex shapes.

In advantageous embodiments of the present invention that can be combined in any possible manner:
the axes of the protuberant tips lead substantially to a geometrical center of the writing instrument; the protuberant tips are then divergent and they form a large amount of space between them, thereby making the writing instrument more comfortable to use, and increasing the selectivity of the colors;
the length of a protuberant tip as measured from its base to its vertex lies in the range one fourth of the distance between a geometrical center of the writing instrument and the tip of the protuberant tip to two-thirds of the distance, thereby making it possible to obtain a satisfactory compromise between the length of time for which the tip can be used, the strength with which its base is fastened to the central body, and the ergonomics of the writing instrument;
the central body is formed, at least in part, of a plastics material that is advantageously elastic, in order to reinforce overall strength;
the protuberant tips extend substantially in the same plane, the angular spacing between the axes of two adjacent protuberant tips preferably lying in the range 50° to 80°, the writing instrument then having two substantially plane opposite faces, making it easier to take hold of it, and enabling the instrument to be laid down flat;
at least three protuberant tips extend, each along a different axis, the axes being contained in distinct respective planes, thereby making it possible to form a large number of writing tips while also making provision for a large angular spacing between the tips so as to facilitate taking hold of the instrument and so as to prevent another writing tip from interfering with the writing surface when writing with a given tip.

The invention also provides a method of manufacturing a writing instrument according to claim 7.

Such a method makes it possible to manufacture a writing instrument that offers the above-mentioned advantages.

In addition, in advantageous embodiments of the present invention that can be combined in any possible manner:
the second pastel material is fed into the mold after the first pastel material fed into the mold has solidified, at least partially, and the third pastel material is fed into the mold after the second pastel material fed into the mold has solidified, at least partially, thereby preventing the different pastel materials fed in from mixing, and thus preventing the various colors from mixing;
the mold is stationary and the pastel materials fed into the mold via the filling well form superposed layers, which offers the advantage of constituting a particularly simple and fast mode of manufacture;
the mold is a moving mold, and the angular-positioning of the mold is changed each time a pastel material is fed in, which makes it possible to control filling each volume corresponding to a protuberant tip accurately and independently; and
at least two filling wells are provided in the mold, and certain filling wells are closed off, depending on the angular-positioning of the mold in order to prevent a pastel material in the molten state from flowing out of the mold.

### BRIEF DESCRIPTION OF THE DRAWINGS

Other features and advantages of the present invention appear from the following description of non-limiting embodiments, given with reference to the accompanying drawings, in which:

FIG. 1 is a diagram showing a writing instrument made of pastel material in an embodiment of the present invention;

FIG. 2 is a diagram showing a writing instrument made of pastel material in another embodiment of the present invention; and

FIG. 3 is a diagram showing a mold used to manufacture a writing instrument in an implementation of the present invention.

FIG. 1 shows an example of a writing instrument of the present invention. Such a writing instrument 1 is made of natural and/or synthetic waxes to which fillers can be added. The writing instrument 1 has protuberant tips 2 to 6, each of which is formed of a pastel material of color different from the colors of two other protuberant tips. The colors are advantageously obtained by adding pigments to the pastel material. In the embodiment shown in FIG. 1, the protuberant tip 2 has a first color, the protuberant tips 3 and 6 have a second color, and the protuberant tips 4 and 5 have a third color. The writing instrument 1 thus has three different colors.

Each of the protuberant tips 2 to 6 of the instrument 1 extends from a respective base 2a to 6a to a respective vertex 2b to 6b, forming a writing tip for writing in the corresponding color. In the embodiment shown in FIG. 1, each of the protuberant tips extends along a different axis. In other embodiments (not shown in the figures), some of the protuberant tips could extend along the same axis, e.g. in opposite directions.

In the example shown in FIG. 1, the axes of the protuberant tips 2 to 6 lead approximately to a geometrical center C of the instrument 1. By means of this arrangement, the protuberant tips diverge from one another, thereby making the writing instrument more comfortable to use, in particular by making the instrument easy to hold in the hand. In addition, the resulting spaces between the various protuberant tips make it easy to select one of the tips for writing in the corresponding color.

It should be noted that the length of each protuberant tip of the instrument 1 is sufficiently large for it to be used as a writing tip for a predetermined period of use. However, its length is also sufficiently small to guarantee that its base is connected with the required strength to the central body 7 of the instrument, and to facilitate taking hold of the writing instrument. Thus, the length of each protuberant tip of the writing instrument, e.g. the protuberant tip 2 of the instrument 1, as measured between its base 2a and its vertex 2b, advantageously lies in the range one fourth of the distance between the geometrical center C of the instrument 1 and the vertex 2b of the protuberant tip 2 to one two-thirds of the distance. Naturally, other length ratios are also imaginable depending on whether priority is given to the ergonomics of the instrument, to its strength, or to the length of time for which it can be used. Similarly, the protuberant tips of the writing instrument can have mutually different lengths, by preferring, for example, long lengths for the protuberant tips that have colors that are used frequently.

In the embodiment shown in FIG. 1, each of the protuberant tips 2 to 6 is formed integrally with the central body 7. Thus, the writing instrument 1 is made entirely of pastel material, so as to form a one-piece instrument. The bonding between each of its protuberant tips is achieved chemically, the pastel material of which each of the tips is made being of the same chemical nature. Such chemical bonds thus impart appropriate strength to the writing instrument 1.

Advantageously, the central body 7 includes a plastics material, or optionally an elastic material, so as to reinforce the one-piece writing instrument.

In addition, in the example shown, the writing instrument 1 is substantially star-shaped, i.e. the protuberant tips 2 to 6 extend approximately in the same plane, and the protuberant tips are distributed around the central body 7. The distribution of the tips is such that two adjacent tips have a determined angular spacing. By way of example, the tips 2 and 6 extending respectively along the axis d and along the axis d′ from the geometrical center C of the instrument 1 have an angular spacing a between them. Advantageously, the angular spacing a between two protuberant tips, e.g. the angle, lies in the range 50° to 80°. The shape of the writing instrument shown in FIG. 1 is such that the instrument has substantially two opposite faces (only one of which can be seen in FIG. 1). These faces are advantageously plane or with only a small amount of relief, so as to facilitate taking hold of the writing instrument 1 and so as to enable the instrument to lie down flat on one of its faces, while it is not being used.

It can be understood that the example of an instrument shown in FIG. 1 is non-limiting. In particular, a different distribution of the colors can be imagined for the writing instrument 1. For example, each of the protuberant tips 2 to 6 could have a color that is different from the colors of the others, so that the writing instrument has five distinct colors that can be used selectively.

In addition, other writing instrument shapes can also be imagined in the context of the invention. For example, the writing instrument can have protuberant tips extending along axes contained in different planes around a central body. Such an arrangement makes it possible to increase the number of protuberant tips, and thus potentially the number of usable colors, and the overall length of time for which the writing instrument can be used. A pebble-shape can thus constitute an advantageous overall shape for such a writing instrument. In general, preference is given to shapes making the writing instrument very easy to handle and very comfortable to use for its user.

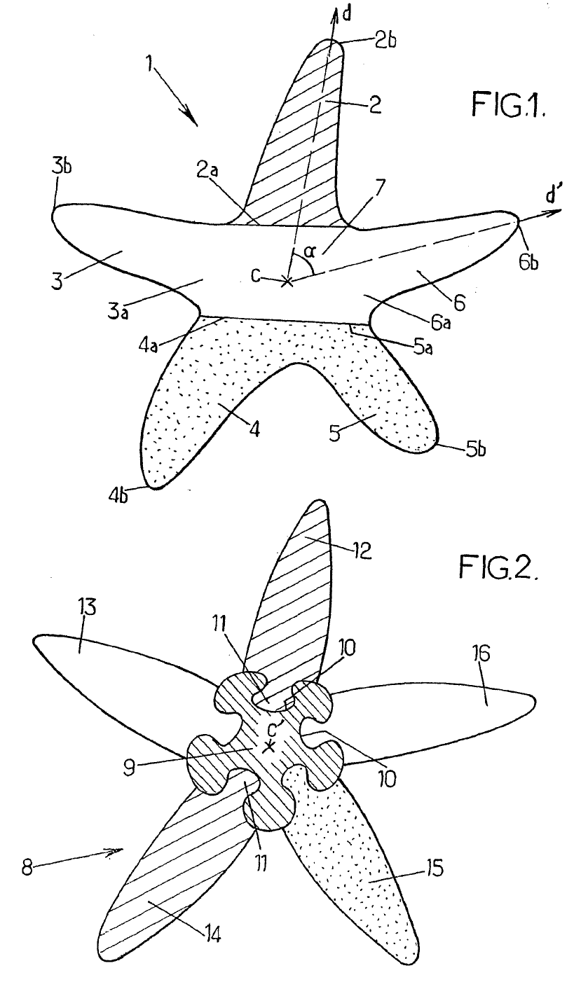

FIG. 2 shows a second embodiment of the invention, in which the writing instrument 8 is not in one piece, unlike the writing instrument 1 of FIG. 1. In the second embodiment, the writing instrument 8 has a central body 9 in the form of a piece distinct from the protuberant tips 12 to 16. Each of the five protuberant tips 12 to 16 extends from a base adjoining the central body 9 to a vertex suitable for serving as a writing tip. The central body 9 is provided with recesses 10 suitable for receiving complementary lugs 11 formed at the base of each of the protuberant tips. This arrangement thus provides mechanical coupling between the protuberant tips 12-16 and the central body 9.

Advantageously, the central body is formed entirely or partially of a plastics material having a certain amount of elasticity, so as to allow the protuberant tips made of pastel material to be inserted into the corresponding recesses, while also retaining each of the tips after insertion. The lugs 11 can, for example, be fastened in the corresponding recesses 10 by snap-fastening.

It should be noted that, in the example shown in FIG. 2, the writing instrument 8 is star-shaped in overall shape, the protuberant tips 12-16 extending along different axes leading substantially to the geometrical center C′ of the central body 9, and being distributed angularly around the central body. In addition, it should be noted that the writing instrument 8 has three distinct colors: a first color for the tips 12 and 14, a second color for the tips 13 and 16, and a third color for the tip 15. Naturally, other writing instrument shapes and other color distributions are also imaginable in the embodiment shown in FIG. 2.

A method of manufacturing a writing instrument of the invention is described below. Such a manufacturing method can advantageously be used for manufacturing the writing instrument 1 of FIG. 1.

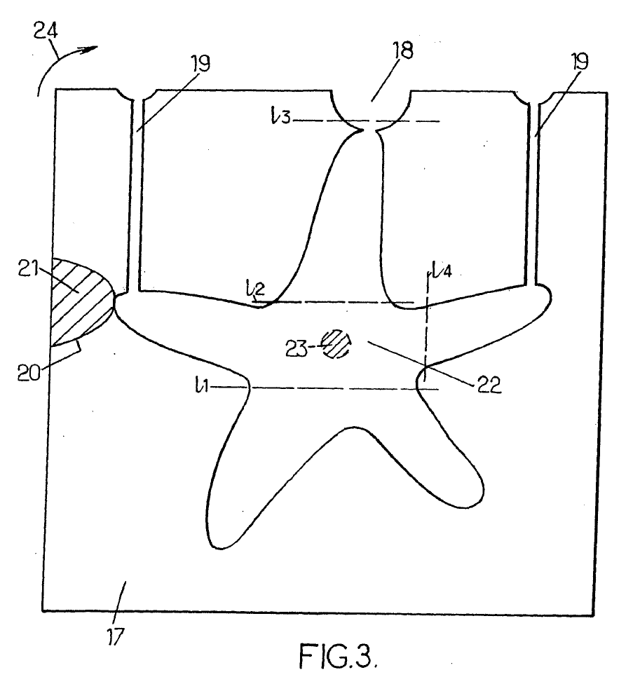

For this purpose, a mold 17 is used that has an internal cavity 22 having a general shape corresponding to the writing instrument that is to be manufactured, as shown in FIG. 3. This mold 17 also has a filling well 18 and vents 19 making it possible for the cavity 22 to communicate with the outside of the mold 17.

In the method, firstly a first pastel material in the molten state is obtained, this pastel material having a first color, e.g. the color that is desired for the bottom tips 4 and 5 of the writing instrument 1. This pastel material is then fed into the mold 17 via the filling well 18, in the molten state, which is a liquid or semi-liquid state. The quantity of pastel material fed in corresponds approximately to the amount required for the protuberant tips that are to be formed. This implies pouring a quantity of pastel material such that it flows under gravity towards the bottom of the cavity 22, corresponding to the protuberant tips 4 and 5 of the instrument 1, until it reaches a first level 11 corresponding substantially to the respective bases 4a and 5a of the tips 4 and 5.

Then, a second pastel material having a second color, such as the color desired for the protuberant tips 3 and 6 of the writing instrument 1 of FIG. 1, can be obtained in a molten state. It is then possible to feed the material in its molten state into the mold, e.g. via the filling well 18 so as to fill a portion of the cavity 22 that extends between the level 11 and a second level 12. Advantageously, the second pastel material is fed into the mold 17 after a certain cooling time for which the first pastel material fed in previously is left to cool. This prevents the first and second pastel materials from mixing, thereby causing the corresponding colors to mix.

Finally, the method proceeds in the same way by obtaining a third pastel material having a color that is distinct from the colors of the preceding pastel materials, such as the color desired for the top tip 2 of the writing instrument 1. This third pastel material is fed into the mold 17 via the filling well 18 and flows down under gravity to cover the preceding layer and to extend between the level 12 and a new level 13 corresponding substantially to the vertex of the top protuberant tip. As with the preceding material, it is preferable to feed in the third pastel material only once the second pastel material has cooled, at least partially, in order to avoid undesired mixing of colors.

The method described above with reference to FIG. 3 then makes it possible to obtain a writing instrument such as the instrument shown in FIG. 1. Such an instrument has superposed layers of pastel materials, the protuberant tips of the same level having the same color. In addition, since the pastel materials used are of the same chemical nature, chemical bonding is obtained between the various layers of pastel material, so that the resulting writing instrument constitutes a one-piece object whose various portions are not easy to separate.

Naturally, the cavity 22 of the mold 17, and the levels that each of the pastel materials fed into the mold must reach vary as a function of the type of writing instrument that is to be manufactured, in particular as a function of its shape and of the imagined distribution of colors.

In the above-described implementation, the mold 17 is stationary. Each of the pastel materials fed into the mold via the filling well 18 then flows under gravity towards the bottom of the mold, so as to form superposed layers. In another implementation, the mold 17 is a moving mold rather than a stationary mold. The angular position of the mold is then changed each time a new pastel material is fed in. By way of example, a first pastel material is fed into the mold 17 via the filling well 18 so that it flows towards the bottom of the cavity 22 until it reaches the level 11. Then, once the first pastel material has cooled sufficiently, the mold 17 is pivoted through 90° clockwise (arrow 24) and a second pastel material in the molten state is fed in via a second filling well 20, so that the second pastel material flows under gravity towards the portion of the cavity 22 that is furthest to the right in FIG. 3, until it reaches a filling level 14. It is thus possible to obtain a writing instrument in which each of the protuberant tips has a color different from the colors of the other tips of the same level.

Care is taken to prevent pastel materials cast in the molten state from being able to escape via orifices provided in the mold 17, such as filling wells or vents. Thus, as shown by way of example in FIG. 3, a stopper 21 can be inserted into the filling well 20 when it is not being used for pouring in a pastel material.

In a variant of the above-described implementation, a filling well 23 is arranged to open out into the cavity 22 at the center thereof rather than at the vertex of a tip as with the filling wells 18 and 20. Thus, the same filling well 23 can be used to fill the entire cavity while the mold 17 is pivoted about a horizontal axis. In which case, the precautions to be taken to avoid a pastel material in the molten state flowing out via through orifices leading from the cavity 22 need to be taken only for the vents 19 and no longer for any other filling orifice.

1-11. (canceled)

12. A writing instrument having a central body and writing tips made of pastel material, the writing instrument having at least three protuberant tips, each of which is formed of a pastel material of a color different from the colors of two others of the protuberant tips, the protuberant tips extending along different axes, each from a base integral with or secured to the central body to a vertex forming a writing tip for writing in the corresponding color, the protuberant tips being formed integrally with the central body, and the pastel materials being of the same chemical nature.

13. A writing instrument according to claim 12, in which the axes of the protuberant tips lead substantially to a geometrical center of the writing instrument.

14. A writing instrument according to claim 12, in which the length of a protuberant tip as measured from its base to its vertex lies in the range one fourth of the distance between a geometrical center of the writing instrument and the tip of the protuberant tip to two-thirds of the distance.

15. A writing instrument according to claim 12, in which the central body is formed, at least in part, of a plastics material.

16. A writing instrument according to claim 12, in which the protuberant tips extend substantially in the same plane, the angular spacing between the axes of two adjacent protuberant tips preferably lying in the range 50° to 80°.

17. A writing instrument according to claim 12, in which at least three protuberant tips extend, each along a different axis, the axes being contained in distinct respective planes.

18. A method of manufacturing a writing instrument, in which method, a mold is provided having a cavity defining a central body from which at least three protuberant tips extend along different axes, each protuberant tip extending from a base contiguous with the central body to a vertex, and at least one filling well putting the cavity into communication with the outside of the mold, the method comprising the following steps:
obtaining a first pastel material in the molten state having a first color;
feeding a quantity of the first pastel material corresponding at least to the volume of a first one of the protuberant tips into the mold, via the filling well, the mold being angularly positioned such that the first pastel material flows into the volume of the first protuberant tip;
obtaining a second pastel material in the molten state having a second color;
feeding a quantity of the second pastel material corresponding at least to the volume of a second one of the protuberant tips into the mold, via the filling well, the mold being angularly positioned such that the second pastel material flows into the volume of the second protuberant tip;
obtaining a third pastel material in the molten state having a third color; and
feeding a quantity of the third pastel material corresponding at least to the volume of a third one of the protuberant tips into the mold, via the filling well, the mold being angularly positioned such that the third pastel material flows into the volume of the third protuberant tip.

19. A method according to claim 18, in which the second pastel material is fed into the mold after the first pastel material fed into the mold has solidified, at least partially, and the third pastel material is fed into the mold after the second pastel material fed into the mold has solidified, at least partially.

20. A method according to claim 18, in which the mold is stationary and in which the pastel materials fed into the mold via the filling well form superposed layers.

21. A method according to claim 18, in which the mold is a moving mold, and in which the angular-positioning of the mold is changed each time a pastel material is fed in.

22. A method according to claim 18, in which at least two filling wells are provided in the mold, and in which certain filling wells are closed off, depending on the angular-positioning of the mold in order to prevent a pastel material in the molten state from flowing out of the mold.
